(19) United States
(12) Patent Application Publication
(10) Pub. No.: US 2002/0083307 A1
(43) Pub. Date: Jun. 27, 2002

(54) System and method for partial merges for sub-register data operations

(76) Inventors: David J. Sager, Portland, OR (US); Alan B. Kyker, Davis, CA (US); Andy F. Glew, Portland, OR (US)

Correspondence Address: KENYON & KENYON, 1500 K STREET, N.W., SUITE 700, WASHINGTON, DC, 20005, US

(21) Appl. No.: 09/745,549

(22) Filed: Dec. 26, 2000

(51) Int. Cl. G06F 9/00

(52) U.S. Cl. 712/224

(57) ABSTRACT

Embodiments of the present invention relate to systems and methods for partial merges for sub-register data operations. An instruction is examined before execution to determine which portion of a source register identified in the instruction should remain unchanged into a destination register. A portion of the source register determined to remain unchanged is moved into the destination register before instruction execution is complete.

### FIELD OF THE INVENTION

Embodiments of the present invention relate to data processing within micro-processors. More particularly, embodiments of the present invention relate to systems and methods to maintain architecture compatibility between operations and data registers of different bit-lengths.

### BACKGROUND OF THE INVENTION

In the electronic arts, processors use instructions to manipulate data within a plurality of registers. These instructions may be executed, for example, by adding or moving data from one or more source registers into a destination register. In earlier processors, these instructions designated specific registers of the processors for which data may be manipulated. In contrast, modern processors contain a pool of registers, each of which is not identified with any particular designation.

In order to keep track of registers that are designated by various instructions, a renamer may use a lookup table. This renamer can permit instructions to be executed and re-executed out of order. Illustrated in FIG. 1 is an embodiment of a renamer 100. The renamer 100 consists of a lookup table 120 including a plurality of entries 120a, 120b, 120c and a pool of registers 110 including a plurality of registers 110a, 110b, 110c, 110d, 110e, 110f. Various entries 120a, 120b, 120c may be associated with various registers 110b, 110d, 110e via connectors 130a, 130b, 130c.

FIG. 1 also illustrates an example of processing the instruction ADD EAX, EBX. In this instruction, the values presently in registers designated EAX and EBX are added and the result placed in the EAX register. In this embodiment, although EAX is both a source and destination register for the addition, a different register is selected from the pool of registers for the destination of the sum of EAX and EBX. For example, the renamer ensures that the register #97 contains the value for the EAX source register, register #1 contains that value for the EBX register, and register #3 contains that value for the EAX destination register. Thus, although the instruction implies that a single register be used as both a source and destination, different registers in fact are used. The label “EAX” actually refers to different physical registers at different points in the instruction stream.

However, an architecture compatibility problem arises when an operation yields a result that is a different bit-length than the source and destination registers. For example, when an 8 or 16 bit result occurs after an operation, the renamer may need to insert this 8 or 16 bit result into a newly allocated 32 bit register. This newly allocated register has no assigned value for the other 24 or 16 bits, respectively. To maintain compatibility with the architecture, the unchanged bits of the relevant source register can be merged with the 8 or 16 bit result to form the full 32 bit result.

Typically, the merge occurs when the instruction is retired. For example, the Pentium® Pro P6 processor (manufactured by Intel Corporation of Santa Clara, Calif.), supports 8 and 16 bit operations. To merge an 8 or 16 bit result with the unchanged bits of a register, the P6 uses a Retired Register File (RRF). The RRF maintains copies of each of the eight physical registers of the ×86. When an instruction is retired (which can occur well after the instruction was executed), the 8, 16, or 32 bit result of the instruction is transmitted to the RRF. Using its copy of the register in question, the RRF merges the result of the retired instruction along with the unchanged bits of the relevant source register. This provides a full 32 bit result with the unchanged bits intact to maintain architecture compatibility.

This implementation can cause “partial stalls.” The RRF only merges an 8 or 16 bit result with the source register's unchanged bits upon the retirement of the instruction, and instructions are often retired well after they are executed. Accordingly, if a new instruction seeks to use the full 32 bits from a register that only has an 8 or 16 bit result because a previous instruction involving that register has not yet been retired, the machine performs a partial stall until the full 32 bits of the register becomes available. When this partial stall occurs, the machine waits until all the logically preceding instructions involving the register are retired. Once all the necessary instructions are retired, the full 32 bits become available for use in the register in question. The new instruction waiting to use all 32 bits of that register can then be executed. These partial stalls can result in a substantial performance loss.

### BRIEF DESCRIPTION OF THE DRAWINGS

FIG. 1 is a block diagram depicting a renamer which coordinates a pool of registers.

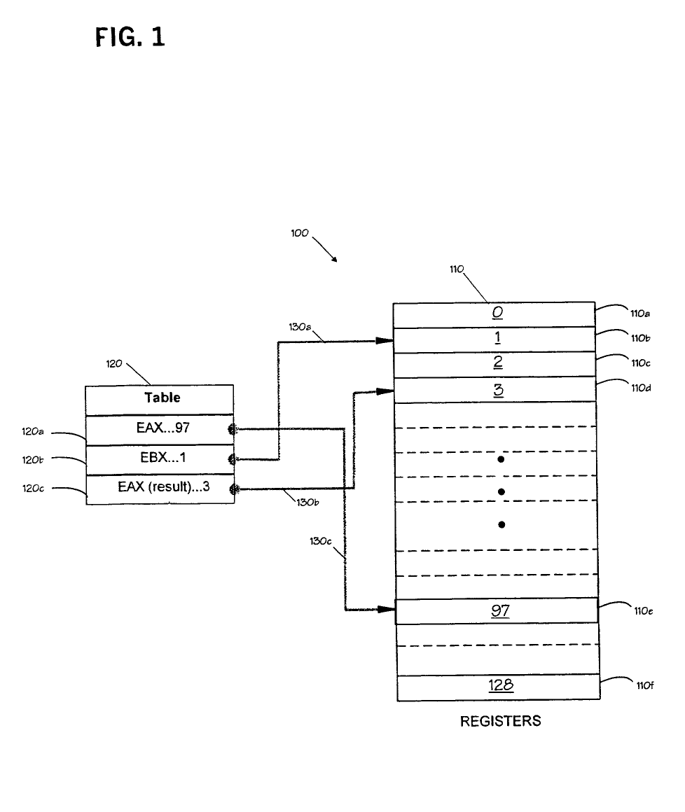

FIG. 2 is a block diagram depicting the addition of a portion of two source registers with the result placed in a destination register in accordance with embodiments of the present invention.

FIG. 3 is a block diagram depicting the move of a preset number from a source register to a destination register in accordance with embodiments of the present invention.

FIG. 4 is a block diagram of a partial merge system in accordance with embodiments of the present invention.

FIG. 5 is a diagrammatic representation of merge logic in accordance with embodiments of the present invention.

### DETAILED DESCRIPTION

Embodiments of the present invention perform partial merges “on the fly” rather than at instruction retirement. Accordingly, the performance losses that could arise from partial stalls are eliminated. Advantageously, in accordance with embodiments of the present invention, there is no need to maintain a RRF.

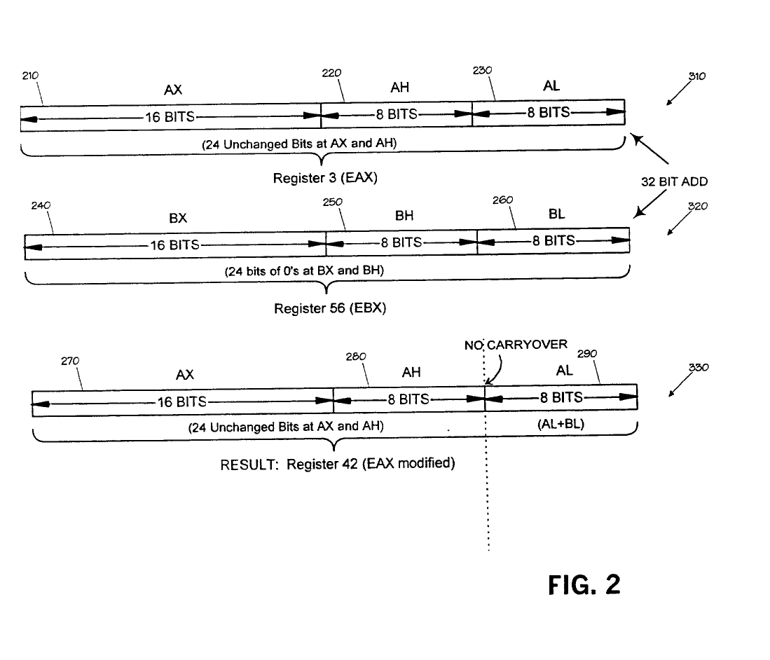

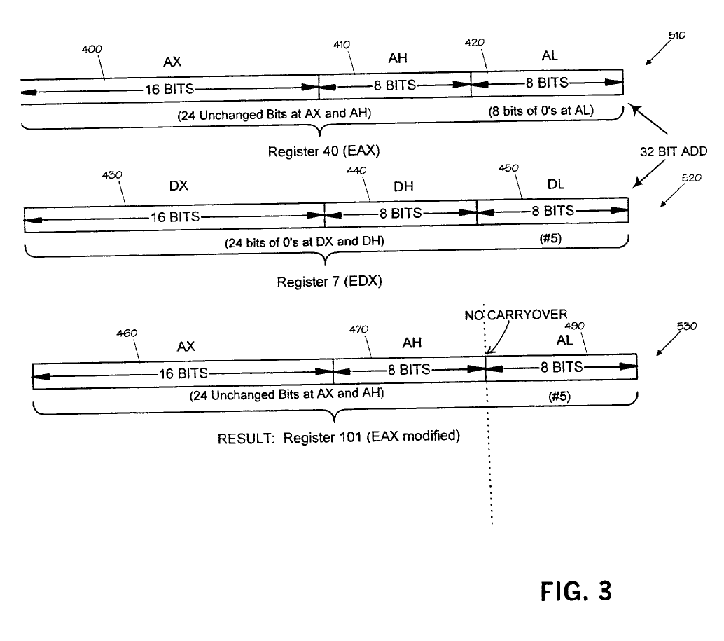

FIGS. 2 and 3 show a plurality of exemplary registers to demonstrate the partial merge technique in accordance with embodiments of the present invention. These exemplary embodiments utilize 8 bit operations with 32 bit source and destination registers. The present invention may be applied to operations involving registers that may include operations using greater than (or less than) 8 bits, and/or utilizing source and destination registers that may be greater than (or less than) 32 bits.

FIG. 2 shows the operation of an embodiment of the present invention using source registers 310, 320 and destination register 330. The partial merges technique of the present invention can be illustrated using the instruction, for example, <ADD AL, BL> (i.e., add 8 bit AL and 8 bit BL and place the result into AL). In this example, AL 230 and BL 260 can be referred to as the low-order bits (e.g., having low-order bit positions 0-7) of Register 3 (EAX) 310 and Register 56 (EBX) 320, respectively. For reference, register 310 may be referred to as the “top operand” of the instruction while register 320 may be referred to as the “lower operand.” Although only 8 bits are identified to be the low-order bits in this example, any number of bits less than the full width of the source and destination registers can be identified as the low-order bits. Thus, bits AX 210 and AH 220 can be identified as the high-order bits (e.g., having high-order bit positions 8-31) of register 310, while bits BX 240 and BH 250 can be identified as the high-order bits (e.g., having high-order bit positions 831) of register 320.

The registers may be mapped in preparation for a 32 bit add of register 310 and register 320, which incorporate AL 230 and BL 260 respectively, and places the result in Register 42 (EAX modified) 330 (result or destination register 330). In this example, AX 270 and AH 280 can be identified as the high-order bits (e.g., having high-order bit positions 8-31) of the destination register, register 42. Bits AL 290 are identified as the low-order bits (e.g., having low-order bit positions 0-7) of Register 42 (EAX modified), containing the result of the executed instruction (e.g., AL+BL). A renamer (not shown) may use a pool of registers such that the EAX source register 310 and EAX destination register 330 are actually different registers.

According to an embodiment of the present invention, merge logic (to be described below in detail) may place 0's in bit positions 8 to 31 (covering BH 250 and BX 240—i.e., the high-order bits 240 and 250) of register 56. When register 310 and register 320 (having 0s in the high-order bit positions) are added together over all 32 bits and the results are placed into register 330, the high-order bits of relevant source register 310 flow through to the destination register 330. Thus, architecture compatibility can be maintained since the destination register 330 ends up with the unchanged high-order bits (e.g., the first 24 bits) of register 310 and the 8 bit addition results of the low-order bits of registers 310 and register 320 (i.e., AL+BL). To that end, the merge logic may provide that the add function ignore the carryover from the most significant bit (bit 7) of the AL and BL addition into the least significant bit (bit 8) of AH 280. Thus, the destination register 330 contains sections AX 270 and AH 280 that were formerly present in the source register (i.e., the high-order bits) and section AL 290 (i.e., the low-order bits) that is the result of the addition of section AL 230 of register EAX 310 and section BL 260 of register EBX 320. By doing so, the merging logic allows the execution of an instruction based on 8 or 16 bit addition while maintaining the advantage of using a pool of 32 bit registers using a renamer.

Some instructions may require the merge logic to manipulate more than a single register to obtain the proper result in accordance with embodiments of the present invention. FIG. 3 illustrates an example of the operation of the partial merges technique using such an instruction. For instruction <MOV AL, DL> (i.e., move DL into the AL register), a renamer may utilize the 8 bit DL portion 450 (i.e., the low-order bits in positions 0-7) of the 32 bit Register 7 (EDX) 520 (register 520) to store, for example, the #5 (i.e., the contents of DL). It is recognized that greater or lesser number of bits can be moved in embodiments of the present invention. To execute the instruction in this embodiment, the merge logic may perform a 32 bit add of Register 40 (EAX) 510 (register 510) to register 520 and places the result in Register 101 (EAX modified). As illustrated in FIG. 3, the merge logic places 0's in the AL portion 420 (i.e., low-order bits 0-7) of register 510 and the DX portion 430 and DH portion 440 (i.e., the high-order bits in positions 8-31) of register 520. Thus, when the 32 bit add of register 510 with register 520 is completed, the #5 is moved into the AL portion 490 (i.e., the low-order positions) of register 530, and the other portions AX 460 and AH 470 (i.e., the high-order bits in positions 8-31) of register 510 remain the same. Again, the merge logic may provide that the add function ignore the carryover from bit 7 into the first bit (bit 8) of AH 470.

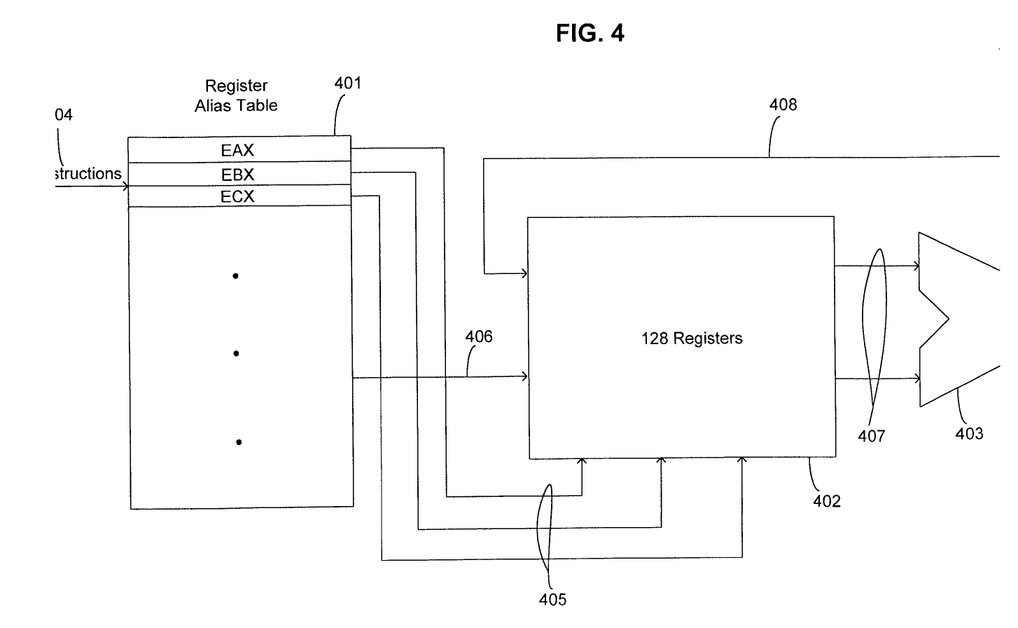

FIG. 4 is a simplified system block diagram in accordance with embodiments of the present invention. The system may include a register alias table (or renamer) 401 stored in a memory (e.g., a RAM). Of course, the memory may include a plurality of read ports and a plurality of write ports for data reads and/or writes. The register alias table 401 may receive input operation instructions 404 to perform register operations from a processor (not shown). The input operation instructions may include the instructions for performing, for example, ADD, MOVE, OR, AND, Shift and/or any other suitable operation. The register alias table 401 may include a plurality of data registers EAX, EBX, ECX, etc. The register alias table 401 may input data from the data registers EAX, EBX, ECX, etc. to a pool of registers 402 using connections 405. The register alias table 401 may assign register positions in the pool of registers 402 for the data or registers provided with the instructions. For example, if the instruction(s) 404 is an ADD instruction, for example, <ADD AL, BL>, the alias table 401 may assign the registers that contain AL and BL to registers positions located in the pool of registers 402. After the register assignments are made, the data and associated register assignments may be forwarded to the pool of registers 402 via connection 406. The contents of the registers from the register alias table 401 may be placed in the renamed registers in the pool of registers 402. In this example, the pool of register 402 may include 128 registers. However, it is recognized that the pool of registers may be greater than or less than 128 registers. The registers in the register alias table 401 and pool of registers 402 may be 8 bit, 16 bit, 32 bit, 64 bit, or higher registers.

The pool of registers 402 may be coupled to an adder 403. The adder 403 may be used to perform an add operation on the contents of the registers. In one example, the contents of register EAX (residing in the renamed location of the pool of registers 402) may be added with the contents of register EBX (residing in the renamed location of the pool of registers 402). The register alias table 401 may indicate the destination register where the results of the add instruction should be stored. The contents of the registers are provided to the adder 403 by connections 407 and the results of adder 403 may be input into the pool of registers 402 via connection 408. The results of the adder may be placed in a register in the pool of registers 402 as designated register alias table 401. Accordingly, no instruction designates any particular register to use from the pool of registers 402.

An instruction may indicate that the results of the adder, for example, be placed in one of the source registers, for example, EAX. In operation, however, there is no register dedicated to be EAX or any other register except for a very brief time. Accordingly, any register may be allocated to hold the value that EAX should contain. A moment later a different register may hold the value that EAX should contain. In fact, in typical practice, many versions of EAX are “live” at any given time. Each version may be the value that EAX had at some instant. The many versions of EAX may be kept in many locations in the register pool, randomly selected.

Thus, when an instruction enters and has its registers renamed, the process allocates a new location in the pool of registers to hold the new value for its destination register. Hence, if this instruction had EAX as its destination, a new location randomly selected from available locations in the pool is allocated to hold a new version of EAX that will soon be created. An ADD instruction, for example, is then executed and the result is written to the register pool in the location allocated to hold this new version of EAX.

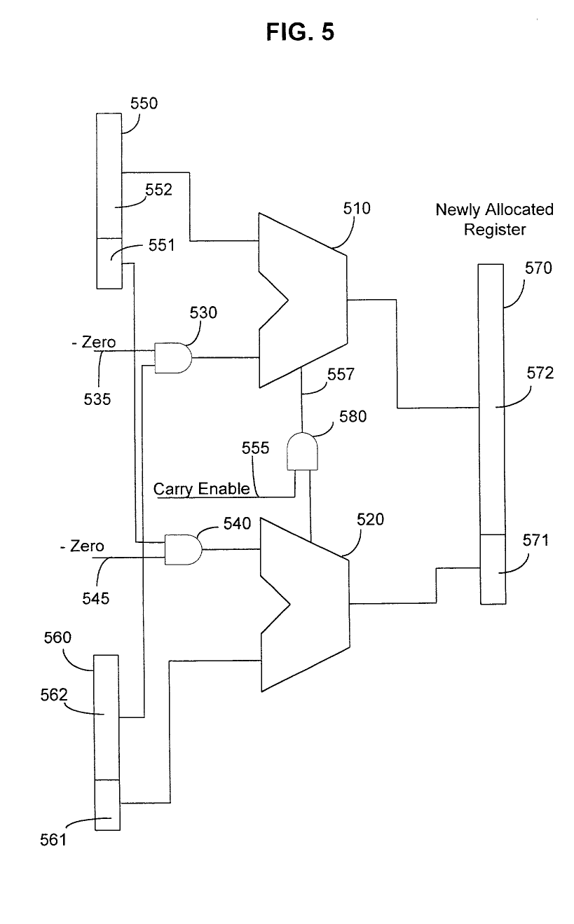

FIG. 5 illustrates an example of merge logic that can be utilized to implement the partial merge operations in accordance with embodiments of the present invention. As shown, registers 550 and 560 from the pool of registers may be directly or indirectly coupled to adders 510 and 520. Register 550 may be, for example, register EAX having low-order bits 551 and high-order bits 552. In this example, register 550 can represent the upper operand. Register 560 may be, for example, register EBX having low-order bits 561 and high-order bits 562. Register 560 may represent the lower operand.

The contents of the registers 550,560 are input to the adders 510 and 520, as shown. Adder 510 receives high-order bits 552, 562 from registers 550 and 560, respectively. Adder 520 receives low-order bits 551,561 from registers 550 and 560, respectively. The low-order bits 551 of register 550 (i.e., the upper operand) may be input to adder 520 via “AND” gate 540. The high-order bits 562 of register 560 (i.e., the lower operand) may be input to adder 510 via “AND” gate 530.

The results of adders 510 and 520 may be output to newly allocated register 570 located in the pool of registers. The high-order results from adder 510 may be placed in high-order location 572 of register 570. The low-order results from adder 520 maybe placed in low-order locations 571 of register 570. It is noted that register 570 containing the results of the partial merge operation may be destination register EAX having a physical location different from source register EAX, for example, register 550.

To perform the ADD function described above with respect to FIG. 2, the AND gate 530 forces the high-order bits 562 of register 560 to “0”s when −Zero input 535 is set to “False” (i.e., 0). The −Zero input 545 is maintained as a “True” (i.e., 1) during the operation of the ADD function. Accordingly, when the high-order bits 552 of register 550 are added with the “0”s that are output by the AND gate 530, the unchanged high-order bits of register 550 are advantageously moved into the high-order location 572 of register 570. Meanwhile, with the −Zero input 545 set to “True,” the low-order bits 551 of register 550 may be input to adder 520 via and gate 540. Accordingly, the low-order bits 551 of register 550 are added with the low-order bits 561 of register 560 using adder 520. The results of the adder 520 are input to the low-order location 571 of register 570.

To prevent a carryover from the most significant bit of the low-order results of the adder 520 into the least significant bit of the high-order results of the adder 510, an AND gate, for example, may be positioned between adders 510 and 520, as shown in FIG. 5. Setting the carry enable 555 to “False” will force a “0” to be output from output 557 of the AND gate 580, thus, preventing the carryover. Accordingly, the higher-order bits of the result are effectively copied from the high-order bits of register 550 (i.e., EAX), while the lower-order bits 551, 561 of each register are added and the results are moved into the low-order locations of register 570, thus, completing the ADD function.

The MOVE function described above with respect FIG. 3 can also be implemented using the merge logic shown in FIG. 5. To MOVE, for example, the low-order bits 561 of register 560 into the low-order locations 571 of register 570 while maintaining architecture compatibility, AND gate 540 forces the low-order bits 551 of register 550 to “0”s when −Zero input 545 is set to “False.” Similarly, AND gate 530 forces the high-order bits 562 of register 560 to “0”s when −Zero input 535 is set to “False.” When the high-order bits 552 of register 550 are added with the “0”s that are output by the AND gate 530, the unchanged high-order bits of register 550 are advantageously moved into the high-order locations 572 of register 570. Similarly, when the low-ordered bits 561 of register 560 are added with the “0” s that are output by the AND gate 540, the low-order bits 561 are advantageously moved into the low-order locations 571 of register 570. Accordingly, the higher-order bits of the result are effectively copied from the high-order bits of register 550 (i.e., EAX), while the lower-order bits 561 of register 560 are moved into the low-order locations of register 570, thus, completing the MOVE function. Since a MOVE function typically does not generate a carryover, carry enable 555 can be any value (i.e., “True” or “False”). It is recognized that FIG. 5 illustrates only one example of merge logic that can be utilized to implement the partial merge operations and that one of ordinary skill in the arts can create variations of merge logic in accordance with embodiments of the present invention.

Although the above description relates to partial merge operations involving ADD and MOVE functions, one of ordinary skill in the art, can apply the present invention to logic functions such as AND, OR, XOR, etc., as well as “Shift” functions. Typically, logic functions such as AND, OR, XOR etc. may not require the carryover to be blocked. In a “Shift” function, the amount to shift may be received as one operand and the data to shift may be received as the other operand. If the result is not full width, the rest of the output is filled with the corresponding bits from this input operand. By controlling the −Zero inputs 535 and 545 as described above, the merge logic shown in FIG. 5 can be applied to other logic functions (e.g., AND, OR, XOR, etc.) to implement the partial merge operation.

In some cases, an operation may require two sources that may be different from the destination. An example of such an operation is the “Load” operation. In its general form, this operation needs a source operand for the base register and another source operand for the index register. The data loaded from memory may be input to yet another register. Typically, if this data is less than full register width, then neither of the 2 source operands supplies the previous state of the destination register to fill the destination register with. One solution would be for this operation to have 3 source registers. The extra register may be used to supply the previous state of the destination register for use in filling the destination register.

An alternative solution may be to use a second operation following the basic load function, if the size of the load result is less than the full register width. This second operation may read the result of the basic load from which it passes the correct bits for the size to its destination. It's second source is the previous state of the destination register, from which it passes the rest of the bits to fill the full register width to the destination.

Embodiments of the present invention relate to operations in which an operation result has a smaller bit-length than the destination register that stores the operation result. To maintain backward compatibility, the portion of the relevant source register that is not referenced by the operation can flow through to the destination register unchanged. Embodiments of the present invention maintain this architectural integrity at the time of the operation, not at some later time. Thus, embodiments of the present invention can result in higher performance by eliminating partial stalls, which are caused when register values need to be merged after the instructions are executed, but before they are retired. Embodiments of the present invention allow the results of an instruction to be merged into registers of greater bit-length without having to stall the processor.

It can be appreciated by those skilled in the art that the specific embodiments disclosed above may be readily utilized as a basis for modifying or designing other methods and techniques related to embodiments of the present invention. It can also be realized by those skilled in the art that such equivalent constructions do not depart from the spirit and scope of embodiments of the invention as set forth in the following claims.

What is claimed is:

1. A partial merging method for sub-register data operations in a processor, the method comprising:
examining an instruction before execution to identify a portion of a source register identified in the instruction that should remain unchanged into a destination register; and
moving the portion of the source register determined to remain unchanged into the destination register before instruction execution is complete.

2. The method of claim 1, wherein moving the unchanged portion of the source register into the destination register includes setting corresponding source register values to zero.

3. The method of claim 1, wherein the source and destination registers have a greater bit-length than a result bit-length of the instruction.

4. The method of claim 3, wherein the bit-length of the source and destination registers is 32 bits.

5. The method of claim 3, wherein the result bit-length is greater than 1 bit and less than 32 2 bits.

6. The method of claim 3, wherein the result bit-length is greater than 1 bit and less than 16 2 bits.

7. A method for sub-register data operations for executing an instruction, the method comprising:
executing the instruction on a first register and a second register; and
merging a result of the executed instruction with a plurality of high-order bits from the first register, the plurality of high-order bits being copied into high-order bit positions of a result register, and the result being placed into low-order bit positions of the result register.

8. The method as recited in claim 7, wherein the merging a result comprises:
modifying contents of the second register by placing data values of zero in the high-order bit positions of the second register;
adding contents of the first register with the modified second register; and
placing the result in the result register.

9. The method as recited in claim 8, the method further comprising:
ignoring a carryover of the result from the low-order bit positions of the result register to the high-order bit positions of the result register.

10. The method as recited in claim 7, wherein the merging a result comprising:
modifying contents of the first register by placing data values of zero in the low-order bit positions of the first register;
modifying contents of the second register by placing data values of zero in the high-order bit positions of the second register;
adding the modified first register with the modified second register; and
placing the result in the result register.

11. The method as recited in claim 10, the method further comprising:
ignoring a carryover of the result from the low-order bit positions of the result register to the high-order bit positions of the result register.

12. The method of claim 7, wherein the first register and the second register have 32 bits.

13. The method of claim 7, wherein the result register has 32 bits.

14. The method of claim 7, the method further comprising:
using a renamer to assign the first register, the second register, and the result register.

15. The method of claim 7, wherein the result of the executed instruction is less than 32 bits.

16. The method of claim 15, wherein the result of the executed instruction is less than or equal to 16 bits.

17. The method of claim 16, wherein the result of the executed instruction is less than or equal to 8 bits.

18. The method of claim 7, wherein the merging a result is performed before instruction execution is complete.

19. A processor comprising:
an instruction set having an instruction;
a source register and a destination register referenced by the instruction from the instruction set; and
a logic circuit adapted to examine the instruction before execution to identify a portion of the source register that should remain unchanged into the destination register, and the logic circuit further adapted to move the unchanged portion into the destination register before instruction execution is complete.

20. The processor of claim 19, wherein the logic circuit is adapted to move the unchanged portion into the destination register by setting corresponding values of the source register to zero.

21. The processor of claim 19, wherein the source register and the destination register have a greater bit-length than a result of the instruction.

22. The processor of claim 21, wherein the source register and the destination register have 32 bits.

23. The processor of claim 21, wherein the result of the instruction has less than 32 bits.

24. The processor of claim 23, wherein the result of the instruction is less than or equal to 16 bits.

25. A method for executing instructions in a processor using data registers of different bit lengths while maintaining architecture compatibility, the method comprising:
receiving an instruction to perform an operation on contents of first and second source registers, the contents including a plurality of bits and the operation results being a different bit length then bit lengths of the first and second source registers;
screening the first and second source registers; and
merging the operation results into a destination register when the operation is performed.

26. The method of claim 25, wherein screening the first and second source registers comprising:
identifying high order bits of one of the source registers that should remain unchanged when merged into the destination register; and
modifying the contents of the other source register by setting corresponding high order bits of the other source register to zero.

27. The method of claim 26, wherein merging the operation results comprising:
adding the contents of the one of the source registers with the modified contents of the other source register; and
placing results of the addition in the destination register.

28. The method of claim 27, further comprising:
ignoring a carryover of the addition results from low-order bit positions of the destination register to high-order bit positions of the result register.

29. The method of claim 25, wherein screening the first and second source registers comprising:
modifying contents of one of the source register by setting low order bits of the one of the source registers to zero; and
modifying the contents of the other source register by setting high order bits of the other source register to zero.

30. The method of claim 29, wherein merging the operation results comprising:
adding the modified contents of the one of the source registers with the modified contents of the other source; and
placing results of the addition into the destination register.
